(19) United States
(12) Patent Application Publication
(10) Pub. No.: US 2016/0196925 A1
(43) Pub. Date: Jul. 7, 2016

(54) TUNGSTEN POWDER AND ANODE BODY OF CAPACITOR

(71) Applicant: SHOWA DENKO K.K., Minato-ku, Tokyo (JP)

(72) Inventors: Kazumi NAITO, Tokyo (JP); Ryuichi MITSUMOTO, Tokyo (JP)

(73) Assignee: SHOWA DENKO K.K., Minato-ku, Tokyo (JP)

(21) Appl. No.: 14/910,480

(22) PCT Filed: Jul. 16, 2014
(86) PCT No.: PCT/JP2014/068908

§ 371 Date: Feb. 5, 2016

(30) Foreign Application Priority Data
Aug. 30, 2013 (JP) 2013-179972

(51) Int. Cl. H01G 9/042; H01G 9/15; H01G 9/052; C22C 1/00; B22F 9/04; C22C 27/04; B22F 1/00; H01G 9/00; B22F 1/02

(52) U.S. Cl. CPC H01G 9/042; H01G 9/0029; H01G 9/15; H01G 9/0525; B22F 1/025; B22F 9/04; C22C 27/04; B22F 1/0003; C22C 1/00

(57) ABSTRACT

The present invention provides an electrolytic capacitor which uses, as an anode body thereof, a sintered body that is obtained by sintering a tungsten powder containing zirconium element and/or hafnium element so that the content of one of these elements, which is contained in a larger amount, is 0.04 to 1 mass % and the element(s) is localized in the surface of tungsten particles. The electrolytic capacitor of the present invention has a large capacitance and good LC characteristics, while being suppressed in capacitance variation.

### TECHNICAL FIELD

The present invention relates to a tungsten powder, an anode body for a capacitor, the method for producing the same, and an electrolytic capacitor comprising the anode body.

### BACKGROUND ART

Patent Document 1 (WO 2012/086272) discloses a tungsten powder which has tungsten silicide on the surface of particles and silicon content of 0.05 to 7 mass % and which imparts good leakage current (LC) characteristics to a capacitor; an anode body for a capacitor; an electrolytic capacitor; a method for producing the tungsten powder; and a method for producing the anode body for a capacitor. The document discloses a powder of tungsten-zirconium alloy as an example which failed to attain good LC characteristics.

Patent Document 2 (JP 2007-294875 A; U.S. Pat. No. 7,362,541) discloses a solid electrolytic capacitor, in which an anode is coated with a first metal layer that comprises niobium, aluminum, tantalum or alloy mainly comprising either of niobium, aluminum or tantalum, and a second metal layer that comprises either of titanium, zirconium and hafnium and that coats a part of the surface of the first metal layer, so as to keep leakage current low in a solid electrolytic capacitor comprising an anode, a cathode and a dielectric layer which is formed by anode oxidation.

### PRIOR ART

### Patent Documents

### Patent Document 1: WO 2012/086272

Patent Document 2: JP 2007-294875 A (U.S. Pat. No. 7,362,541)

### DISCLOSURE OF INVENTION

### Problem to be Solved by Invention

Although the electrolytic capacitor using the tungsten powder disclosed in Patent Document 1 had good LC characteristics, it had a problem of great variability in the capacitance.

Accordingly, an object of the present invention is to provide a tungsten powder which is capable of reducing the variation in capacitance in electrolytic capacitors comprising an anode body made of a sintered body of a tungsten powder as a valve-acting metal, an anode body using the same, and an electrolytic capacitor using the anode body as an electrode.

### Means to Solve the Problem

That is, the present invention relates to the following tungsten powder, anode body for a capacitor, electrolytic capacitor, method for producing the tungsten powder, and method for producing the anode body for a capacitor.

(1) A tungsten powder, containing zirconium element and/or hafnium element so that the content of one of these elements, which is contained in a larger amount, is 0.04 to 1 mass % and the element(s) is localized in the surface of tungsten particles.
(2) The tungsten powder as described in (1) above, wherein the zirconium element and/or hafnium element is localized within 50 nm from the particle surface.
(3) The tungsten powder as described in (1) or (2) above, wherein the total content of the zirconium element and the hafnium element is 1 mass % or less.
(4) The tungsten powder as described in any one of (1) to (3) above, which further contains 7 mass % or less of silicon element.
(5) The tungsten powder as described in any one of (1) to (4) above, containing a zirconium-tungsten compound or a hafnium-tungsten compound in the surface of tungsten particles.
(6) The tungsten powder as described in any one of (1) to (5) above, wherein the tungsten powder is a granulated powder.
(7) An anode body for capacitors obtained by sintering the tungsten powder described in any one of (1) to (6) above.
(8) An electrolytic capacitor composed of the anode body for capacitors described in (7) above as one electrode and a dielectric body interposed between the electrode and a counter electrode.
(9) A method for producing a tungsten powder, comprising a step of mixing a zirconium compound and/or a hafnium compound in a raw material tungsten powder, heating the mixture in vacuum to allow the mixed compound to react with the surface of the tungsten powder particles, wherein the blending quantity of the compound is adjusted so that the content of either of zirconium element or hafnium element, which is contained in a larger amount, is 0.04 to 1 mass % in the obtained tungsten powder.
(10) The method for producing a tungsten powder as described in (9) above, comprising a step of mixing a zirconium compound and/or a hafnium compound in a raw material tungsten powder, heating the mixture in vacuum to allow the mixed compound to react with the surface of the tungsten powder particles, wherein the blending quantity of the compound is adjusted so that the total content of zirconium element and hafnium element is 1 mass % or less in the obtained tungsten powder.
(11) The method for producing a tungsten powder as described in (9) or (10) above, further comprising a step of granulating the tungsten powder.
(12) A method for producing an anode body for a capacitor, comprising sintering the tungsten powder described in any one of (1) to (6) above.

### Effects of Invention

By producing a capacitor using the tungsten powder of the present invention, a capacitor which undergoes little variation in capacitance can be obtained.

### MODE FOR CARRYING OUT THE INVENTION

The tungsten powder of the present invention can be obtained by, for example, mixing a raw material tungsten powder with a zirconium compound and/or a hafnium compound and heating the mixture in vacuum to allow the compound to react with the surface of the tungsten powder particles. Therefore, the zirconium element and hafnium element in the obtained tungsten powder tend to be localized in the surface layer of the particles constituting the tungsten powder.

The tungsten powder of the present invention can obtain effects not only by containing either of zirconium element or hafnium in a specified amount, but also by containing both of zirconium element and hafnium element in a specified amount as a total content in the tungsten powder. The content of either of zirconium element or hafnium element, which is contained in a larger amount, is preferably 0.04 to 1 mass % in the tungsten powder of the present invention. Also, when the content of both of zirconium element and hafnium element in the tungsten powder is defined in total, the total content of the zirconium element and hafnium element is preferably 1.2 mass % or less. The total content is more preferably 1 mass % or less because it can reduce the leakage current.

The volume average particle diameter of the tungsten primary powder is preferably 0.1 to 1 μm, more preferably 0.1 to 0.7 μm. The powder having the volume average particle diameter within the above-mentioned range facilitates the production of a capacitor having a large capacitance.

A commercially-available product can be used as a material tungsten powder.

Tungsten powder having a relatively small particle diameter which is more preferable can be obtained by, for example, pulverizing the tungsten trioxide powder under hydrogen atmosphere; or reducing the tungstic acid, salt thereof (ammonium tungstate and the like) and tungsten halide using a reducing agent such as hydrogen and sodium, and appropriately selecting the reducing conditions.

Also, the tungsten powder can be obtained by reducing the tungsten-containing mineral directly or through several steps and by selecting the reducing conditions.

Furthermore, a raw material tungsten powder which was classified so as to have a desired diameter may be used.

As a raw material tungsten powder, a granulated one may be used (hereinafter, a granulated tungsten powder may be simply referred to as a “granulated powder”. Also, an ungranulated tungsten powder may be referred to as a “primary powder” when it is necessary to determine whether the tungsten powder is granulated or not).

Commercially-available products can be used as a material for any of a zirconium compound, a hafnium compound and silicon, which is to be blended into the raw material tungsten powder.

Zirconium element and hafnium element can be incorporated in a tungsten powder by mixing a solution of a commercially-available organic zirconium compound or organic hafnium compound and a tungsten powder and heating the mixture in vacuum. This method can be conducted at the same time as granulation to be described later. An alkoxide compound of zirconium or hafnium is decomposed into metal at a high temperature.

As a solution of an organic zirconium compound and an organic hafnium compound, for example, an alokoxide solution such as a tetrapyrrole compound solution, an acetylacetone solution, a solution of an amide compound and a 1-butanol solution of a butoxide compound can be used. Since a butoxy compound undergoes hydrolysis reaction, it is desirable to mix the solution under an inert gas atmosphere such as nitrogen and argon. If necessary, it is desirable to dilute the solution appropriately with 1-butanol, from which water and oxygen are deleted, to be mixed with the tungsten powder.

To retain a desired amount of zirconium element and hafnium element in the tungsten powder of the present invention, it is necessary to add an alkoxide compound in an amount equivalent to or more than the desired amount in consideration of the yield. A specific blending quantity can be determined by a preliminary experiment. In the case of this method, the zirconium element and hafnium element tend to be localized generally within 50 nm from the surface of the tungsten particles. When the tungsten powder is thus produced, it is assumed that most of the zirconium element and hafnium element exist in the surface layer of the tungsten particles as being a solid solution. Also, part of the zirconium element may exist as being crystals of W₅Zr₃ or W₂Zr and part of the hafnium element may exist as being crystals of W₂Hf in some cases.

When mixing at least one of a zirconium compound, a hafnium compound, and a silicon powder to be described later with the raw material tungsten powder, the tungsten powder may be either of a granulated powder or an ungranulated powder. Preferred is an ungranulated powder because it is easy to be uniformly mixed.

In a preferred embodiment of the present invention, when the tungsten powder of the present invention contains silicon element, the leakage current of a capacitor obtained therefrom can be further suppressed. The silicon content in the tungsten powder of the present invention is preferably 7 mass % or less, more preferably 0.05 to 7 mass %, particularly preferably 0.2 to 4 mass %.

In order to incorporate silicon element in the tungsten powder of the present invention, a raw material tungsten powder blended with silicon powder is used and allowed to react by heating generally at a temperature from 1,200 C.° to 2,000 C.° under reduced pressure of 10⁻¹ Pa or less. This method can be conducted at the same time as granulation to be described later. In the case of using this method, the silicon powder reacts with the tungsten from the surface of the tungsten particles and tungsten silicide such as W₅Si₃ tends to be formed and localized generally within 50 nm from the surface layer of the tungsten particles. Hence, the core of the primary particles remains as a highly-conducting metal, which suppresses the equal serial resistance of the anode body produced using the tungsten powder, which is preferable.

As the silicon powder to be blended into a raw material tungsten powder, it is preferable to use fine powder which facilitates uniform blending with the tungsten powder. The volume average particle diameter is preferably 0.5 to 10 μm, more preferably 0.5 to 2 μm.

The granulated powder can be obtained by adding at least one member of liquid such as ethanol and liquid resin to the primary powder so as to be made into the granules having an appropriate size; and sintering the granules by heating under reduced pressure. Upon granulation, the tungsten powder of the present invention may be obtained when the granulated powder is obtained by using an ungranulated powder in which a zirconium compound and/or a hafnium compound is blended. Specifically, the granulated powder can be produced as follows.

After allowing tungsten ungranulated powder (which may be blended with zirconium element, hafnium element and/or silicon element) to stand at a temperature from 160 to 500° C. under reduced pressure of 10⁴ Pa or less for 20 minutes to ten hours, it was returned to the atmospheric pressure at room temperature, mixed, allowed to stand at a temperature from 1,200 to 2,000° C., preferably at 1,200 to 1,500° C. under reduced pressure of 10² Pa or less for 20 minutes to ten hours, returned to the atmospheric pressure at room temperature, pulverized and classified to adjust the particle diameter distribution, if necessary, to thereby obtain granulated powder. The volume average particle diameter of the granulated powder within a range of preferably 50 to 200 μm, more preferably 100 to 200 μm, is suitable because the powder can smoothly flow from the hopper of the molding machine to a mold.

Next, the obtained tungsten powder of the present invention is molded. For example, a molded body may be produced by blending resin for molding (such as acrylic resin) with the tungsten powder and molding the mixture with a molding machine. The tungsten powder to be molded can be any of the ungranulated powder, granulated powder, and the mixed powder of the ungranulated powder and granulated powder. A granulated powder is preferable because it facilitates achievement of pores suitable for an anode for a capacitor.

In the molded body to be obtained, a wire material or a foil to serve as an anode lead of the capacitor element may be implanted. Examples of the material for the anode lead wire include valve-acting metal such as tantalum, niobium, titanium, tungsten and molybdenum, and alloy of valve-acting metals.

Next, a sintered body can be obtained by sintering the obtained molded body in vacuum. An example of preferred sintering conditions are the temperature from 1,300 to 2,000° C., preferably from 1,300 to 1,700° C., and more preferably from 1,400 to 1,600° C. under reduced pressure for 10 to 50 minutes, more preferably for 15 to 30 minutes.

By subjecting the obtained sintered body with an anode lead, which serves as an anode, a dielectric layer can be formed on the surface of the anode body (including the surface inside the pores and the outer surface) to electrolytic formation. Furthermore, a capacitor element can be obtained by forming a cathode on the dielectric layer. From such a capacitor element, a capacitor composed of an anode body as one electrode, a counter electrode and a dielectric layer interposed between the electrodes can be obtained. The capacitor thus produced generally becomes an electrolytic capacitor.

The above-mentioned cathode may be made of an electrolyte or a semiconductor layer.

When the cathode is made of a semiconductor layer, a solid electrolytic capacitor element can be obtained. For example, a capacitor element can be obtained by subjecting a semiconductor precursor (for example, at least one kind selected from a monomer compound having a pyrrole, thiophene or aniline skeleton and various derivatives thereof) to multiple polymerization reactions on the dielectric layer to form a semiconductor layer comprising a conductive polymer and having a desired thickness. Furthermore, it is preferable that the capacitor element is provided with an electrode layer comprising a carbon layer and a silver layer being sequentially laminated on the semiconductor layer. By encapsulating the capacitor element, a capacitor can be obtained as a product.

### EXAMPLES

The present invention is described below by referring to Examples and Comparative Examples, but the present invention is not limited thereto.

In the present invention, the measurement of the particle diameter and the specific surface area and elemental analysis were carried out by the methods described below unless otherwise noted.

The volume average particle diameter was measured by using HRA9320-X100 manufactured by Microtrac Inc. and the particle size distribution was measured by the laser diffraction scattering method. A particle size value (D₅₀; μm) when the accumulated volume % corresponded to 50 volume % was designated as the average particle size. Since the raw material tungsten powder used in each of Examples and Comparative Examples is measured in a state in which the powder undergoes little agglomeration, the average particle diameter of the primary powder measured by the above method can be regarded almost as an average primary particle diameter.

The contents of elements in the tungsten powder were measured by ICP emission spectrometry by using ICPS-8000E (manufactured by Shimadzu Corporation).

The crystalline state in the tungsten powder was analyzed by X-ray diffractometer (X'pert PRO produced by PANalytical B.V.)

### Examples 1 to 3 and Comparative Examples 1 to 3

Commercially-available zirconium t-butoxide (80% 1-butanol solution) was added to the raw material tungsten powder having a volume average diameter of 0.5 μm obtained by reducing tungsten dioxide with hydrogen so that the resultant mixture has a Zr content (mass %) shown in Table 1. The mixture was allowed to stand under nitrogen gas atmosphere and the pressure of 10³ Pa at 300° C. for 30 minutes. After the mixture was returned to atmospheric pressure at room temperature, it was mixed again and left to stand under the pressure of 10 Pa at 1,360° C. for 30 minutes. After the mixture was returned to atmospheric pressure at room temperature, it was pulverized with a hammer mill and classified through a sieve to thereby obtain granulated powder having a particle size distribution of 26 to 130 μm (volume average particle diameter of 105 μm). Next, after adding 2 parts by mass of acrylic resin to 100 parts by mass of the granulated powder, a molded body was produced using a molding machine TAP2 produced by Seiken Co., Ltd., in which molded body a tantalum wire having a diameter of 0.29 mm was implanted, and sintered under the pressure of 10 Pa at 1,420° C. for 30 minutes. The molded body was returned to atmospheric pressure at room temperature to manufacture 500 units of sintered bodies having a size of 4.45±0.10×1.5±0.04×1.0±0.05 mm (the tantalum wire is implanted in the 1.5×1.0 mm face, 6 mm of which protrudes outside the sintered body) per Example. Table 1 shows the zirconium content (mass %) in the granulated powder of each Example.

### Examples 4 to 7 and Comparative Examples 4 to 5

500 units of the sintered bodies per Example were obtained in the same way as in Example 1 except that the raw material tungsten powder used in Example 1 was classified to obtain a raw material tungsten powder having a volume average particle diameter of 0.3 μm used in the above Examples and Comparative Examples; and a commercially-available hafnium t-butoxide (80% 1-butanol solution) was added instead of the zirconium t-butoxide solution (80% 1-butanol solution) so that the resultant mixture has a Hf content (mass %) shown in Table 2. The sintered body had a size of 4.45±0.13×1.5±0.06×1.0±0.06 mm. Table 2 shows the hafnium content (mass %) in the granulated powder of each Example.

### Examples 8 to 13 and Comparative Examples 6 to 7

500 units of the sintered bodies per Example were obtained in the same way as in Example 1 except that the raw material tungsten powder used in Example 1 was classified to obtain tungsten powder having a volume average particle diameter of 0.1 μm; and hafnium t-butoxide (80% 1-butanol solution) was added in addition to the zirconium t-butoxide solution (80% 1-butanol solution) so that the resultant mixture has a Zr content and a Hf content (mass %) shown in Table 3. The sintered body had a size of 4.44±0.08×1.5±0.08×1.0±0.07 mm. Table 3 shows the zirconium content and hafnium content (mass %) in the granulated powder of each Example.

### Examples 14 to 16 and Comparative Examples 8 to 9

500 units of the sintered bodies per Example were obtained in the same way as in Example 1 except that a commercially available silicon powder (volume average particle diameter of 1 μm) was added at the time of mixing zirconium t-butoxide (80% 1-butanol solution) so that the resultant mixture has a Zr content and a Si content (mass %) shown in Table 4. Table 4 shows the zirconium content and silicon content in the granulated powder of each Example.

### Examples 17 to 19 and Comparative Examples 10 to 11

500 units of the sintered bodies per Example were obtained in the same way as in Example 4 except that a commercially available silicon powder (volume average particle diameter of 1 μm) was added at the time of mixing hafnium t-butoxide (80% 1-butanol solution) so that the resultant mixture has a Hf content and a Si content (mass %) shown in Table 5. Table 5 shows the hafnium content and silicon content in the granulated powder of each Example.

### Examples 20 to 26 and Comparative Examples 12 to 13

500 units of the sintered bodies per Example were obtained in the same way as in Example 8 except that a commercially available silicon powder (volume average particle diameter of 1 μm) was added at the time of mixing zirconium t-butoxide (80% 1-butanol solution) and hafnium t-butoxide (80% 1-butanol solution) so that the resultant mixture has a Zr content, a Hf content and a Si content (mass %) shown in Table 6. Table 6 shows the zirconium content, hafnium content and silicon content in the granulated powder of each Example.

Here, sputtered surface of the granulated powder in each example (except for Comparative Example 1) was analyzed by Auger electron spectroscopy and it was found that zirconium element or hafnium element exists in a range within 30 nm in depth from the particle surface of the granulated powder.

When the granulated powders of Examples 3 and 7 were analyzed by X-ray diffractometer, W₅Zr₃ was detected in the particle surface of the granulated powder of Example 3 as a reaction product and W₂Hf was detected in the particle surface of the granulated powder of Example 7 as a reaction product in a small amount, respectively. That is, it is assumed that a zirconium and tungsten compound or a hafnium and tungsten compound (at least a crystal of the above reaction products) exists in the surface layer of the tungsten powder of the present invention.

When the sputtered surface of the granulated powder of Examples 14 to 26 and Comparative Examples 8 to 13 was analyzed by Auger electron spectroscopy in a similar manner, it was found that tungsten silicide exists in a range within 30 nm in depth from the particle surface of the granulated powder. Furthermore, from the X-ray diffractometric analysis, tungsten silicide was detected in the particle surface of the granulated powder as a reaction product. Most of the detected tungsten silicide was W₅Si₃. That is, it was confirmed that silicon exists as tungsten silicide in at least a part of the surface layer of the particles of the granulated powder.

Each of the sintered bodies of Examples 1 to 26 and Comparative Examples 1 to 13 was used as an anode body of an electrolytic capacitor to thereby measure the capacitance and LC value of the capacitor. The anode body was subjected to chemical conversion in a 0.1 mass % nitric acid aqueous solution at 10 V for five hours to form a dielectric layer on the surface of the anode body. The anode body having a dielectric layer formed thereon was immersed in a 30% sulfuric acid aqueous solution, in which platinum black was provided as a cathode, to form an electrolytic capacitor to thereby measure the capacitance and LC value of the capacitor. The capacitance at room temperature, 120 Hz and bias voltage of 2.5 V was measured by using an LCR meter manufactured by Agilent. The LC value was measured 30 seconds after applying a voltage of 2.5 V at room temperature. The results of each of Examples and Comparative Examples are shown in Tables 1 to 6. Note that the values are an average value of 32 units of the capacitors per example.

As can be seen from Tables 1 to 3, the electrolytic capacitors in Examples 1 to 13 produced from the sintered body of tungsten powder containing zirconium (Zr) element and/or hafnium (Hf) element in a predetermined amount have little variation in capacitance compared to the electrolytic capacitors in Compared Examples 1 to 7 using a sintered body which does not contain a predetermined amount of Zr and/or Hf. Furthermore, it can be seen that an electrolytic capacitor produced from the sintered body in Examples 1 to 12, in which tungsten powder contains 1 mass % or less of zirconium element and hafnium element in total, has a low leakage current. Furthermore, it can be seen that an electrolytic capacitor using a sintered body obtained by subjecting a sintered body of tungsten powder containing a predetermined amount of silicon element as shown in Tables 4 to 6 (Examples 14 to 26) to chemical conversion has little variation in capacitance. Furthermore, it can be seen that an electrolytic capacitor produced from the sintered body in Examples 14 to 24, in which tungsten powder contains 1 mass % or less of zirconium element and hafnium element in total, has a low leakage current.

Although the functional mechanism of zirconium element and hafnium element is not clear, it is assumed that zirconium and hafnium are capable of producing a more uniform and dense dielectric layer because they undergoes a smaller density change compared to tungsten at the time of turning from metal to an oxide by chemical formation, and that is somehow related to the little variation in capacitance and a lower leakage current of a capacitor.

TABLE 1

| | Amount of | Zr content in the | | |
|---|---|---|---|---|
| | added Zr | granulated powder | Capacitance | LC |
| | (mass %) | (mass %) | (μF) | (μA) |
| Example 1 | 0.21 | 0.041 | 356 ± 22 | 6.3 |
| Example 2 | 0.34 | 0.067 | 340 ± 24 | 5.0 |
| Example 3 | 4.6 | 0.905 | 338 ± 16 | 4.9 |
| Comparative | 0 | 0 | 358 ± 48 | 52 |
| Example 1 | | | | |
| Comparative | 0.11 | 0.021 | 348 ± 36 | 49 |
| Example 2 | | | | |
| Comparative | 2.7 | 1.53 | 312 ± 52 | 40 |
| Example 3 | | | | |

In Table 2, the range indicated with “±” means that the values of all the measured samples fall within the range. This holds true in Tables 2 to 6.

TABLE 2

| | Amount of | Hf content in the | | |
|---|---|---|---|---|
| | added Hf | granulated powder | Capacitance | LC |
| | (mass %) | (mass %) | (μF) | (μA) |
| Example 4 | 0.17 | 0.042 | 573 ± 43 | 8.1 |
| Example 5 | 0.24 | 0.059 | 584 ± 56 | 6.3 |
| Example 6 | 2.9 | 0.725 | 582 ± 58 | 7.2 |
| Example 7 | 3.6 | 0.881 | 567 ± 53 | 9.8 |
| Comparative | 0.10 | 0.023 | 425 ± 71 | 49 |
| Example 4 | | | | |
| Comparative | 6.7 | 1.69 | 553 ± 81 | 63 |
| Example 5 | | | | |

TABLE 3

| | | | Content | | | |
|---|---|---|---|---|---|---|
| | | | in the | | | |
| | Addition | | granulated | | | |
| | amount | | powder | | | |
| | (mass %) | | (mass %) | | Capacitance | LC |
| | Zr | Hf | Zr | Hf | (μF) | (μA) |
| Example 8 | 0.22 | 0.04 | 0.041 | 0.010 | 1587 ± 145 | 7.3 |
| Example 9 | 0.10 | 0.17 | 0.020 | 0.041 | 1674 ± 126 | 9.4 |
| Example 10 | 1.2 | 1.6 | 0.22 | 0.39 | 1723 ± 110 | 6.1 |
| Example 11 | 2.0 | 2.4 | 0.37 | 0.58 | 1777 ± 125 | 7.7 |
| Example 12 | 0.40 | 3.3 | 0.072 | 0.81 | 1806 ± 161 | 15 |
| Example 13 | 3.2 | 2.2 | 0.63 | 0.54 | 1706 ± 118 | 60 |
| Comparative | 0.11 | 0.03 | 0.021 | 0.007 | 1502 ± 279 | 36 |
| Example 6 | | | | | | |
| Comparative | 0.06 | 6.2 | 0.012 | 1.5 | 1803 ± 260 | 83 |
| Example 7 | | | | | | |

TABLE 4

| | | | Content | | | |
|---|---|---|---|---|---|---|
| | | | in the | | | |
| | Addition | | granulated | | | |
| | amount | | powder | | | |
| | (mass %) | | (mass %) | | Capacitance | LC |
| | Zr | Si | Zr | Si | (μF) | (μA) |
| Example 14 | 0.21 | 0.055 | 0.041 | 0.051 | 356 ± 19 | 3.6 |
| Example 15 | 3.2 | 0.23 | 0.61 | 0.22 | 372 ± 23 | 1.4 |
| Example 16 | 5.0 | 3.6 | 0.98 | 3.6 | 391 ± 22 | 2.4 |
| Comparative | 0.11 | 7.5 | 0.022 | 7.5 | 348 ± 66 | 261 |
| Example 8 | | | | | | |
| Comparative | 0.05 | 0.030 | 0.011 | 0.03 | 337 ± 44 | 41 |
| Example 9 | | | | | | |

TABLE 5

| | | | Content | | | |
|---|---|---|---|---|---|---|
| | | | in the | | | |
| | Addition | | granulated | | | |
| | amount | | powder | | | |
| | (mass %) | | (mass %) | | Capacitance | LC |
| | Hf | Si | Hf | Si | (μF) | (μA) |
| Example 17 | 0.17 | 0.15 | 0.042 | 0.15 | 569 ± 46 | 7.8 |
| Example 18 | 2.8 | 0.89 | 0.7 | 0.89 | 587 ± 52 | 6.0 |
| Example 19 | 4.0 | 0.62 | 0.98 | 0.062 | 582 ± 55 | 6.8 |
| Comparative | 6.1 | 0.020 | 1.5 | 0.021 | 519 ± 80 | 58 |
| Example 10 | | | | | | |
| Comparative | 0.13 | 7.5 | 0.032 | 7.5 | 487 ± 139 | 551 |
| Example 11 | | | | | | |

TABLE 6

| | | | | Content in the | | | | |
|---|---|---|---|---|---|---|---|---|
| | Addition | | | granulated | | | | |
| | amount | | | powder | | | | |
| | (mass %) | | | (mass %) | | | Capacitance | LC |
| | Zr | Hf | Si | Zr | Hf | Si | (μF) | (μA) |
| Exam- | 0.24 | 0.03 | 0.055 | 0.046 | 0.010 | 0.051 | 1983 ± 102 | 8.9 |
| ple 20 | | | | | | | | |
| Exam- | 0.34 | 0.15 | 0.15 | 0.068 | 0.037 | 0.14 | 2044 ± 111 | 6.3 |
| ple 21 | | | | | | | | |
| Exam- | 1.2 | 1.6 | 0.90 | 0.22 | 0.39 | 0.88 | 2250 ± 100 | 2.1 |
| ple 22 | | | | | | | | |
| Exam- | 2.0 | 2.4 | 0.22 | 0.37 | 0.58 | 0.22 | 2310 ± 113 | 3.2 |
| ple 23 | | | | | | | | |
| Exam- | 0.40 | 3.3 | 4.1 | 0.072 | 0.81 | 4.1 | 2400 ± 133 | 4.7 |
| ple 24 | | | | | | | | |
| Exam- | 3.2 | 2.2 | 4.1 | 0.63 | 0.54 | 4.1 | 2080 ± 116 | 57 |
| ple 25 | | | | | | | | |
| Exam- | 3.2 | 2.2 | 0.040 | 0.63 | 0.54 | 0.038 | 2180 ± 121 | 60 |
| ple 26 | | | | | | | | |
| Com- | 0.10 | 0.02 | 0.040 | 0.018 | 0.005 | 0.039 | 1955 ± 222 | 39 |
| para- | | | | | | | | |
| tive | | | | | | | | |
| Exam- | | | | | | | | |
| ple 12 | | | | | | | | |
| Com- | 0 | 0 | 0.40 | 0 | 0 | 0.40 | 2003 ± 284 | 4.7 |
| para- | | | | | | | | |
| tive | | | | | | | | |
| Exam- | | | | | | | | |
| ple 13 | | | | | | | | |

### INDUSTRIAL APPLICABILITY

As a result of using a sintered body obtained by sintering a tungsten powder containing zirconium element and/or hafnium element so that the content of one of these elements, which is contained in a larger amount, is 0.04 to 1 mass % and the element(s) is localized in the surface of tungsten particles, as an anode body of a capacitor, the variation in capacitance can be suppressed and an electrolytic capacitor having a large capacitance with little variation thereof can be produced.

1. A tungsten powder, containing zirconium element and/or hafnium element so that the content of one of these elements, which is contained in a larger amount, is 0.04 to 1 mass % and the element(s) is localized in the surface of tungsten particles.

2. The tungsten powder as claimed in claim 1, wherein the zirconium element and/or hafnium element is localized within 50 nm from the particle surface.

3. The tungsten powder as claimed in claim 1, wherein the total content of the zirconium element and the hafnium element is 1 mass % or less.

4. The tungsten powder as claimed in claim 1, which further contains 7 mass % or less of silicon element.

5. The tungsten powder as claimed in claim 1, containing a zirconium-tungsten compound or a hafnium-tungsten compound in the surface of tungsten particles.

6. The tungsten powder as claimed in claim 1, wherein the tungsten powder is a granulated powder.

7. An anode body for capacitors obtained by sintering the tungsten powder claimed in claim 1.

8. An electrolytic capacitor composed of the anode body for capacitors claimed in claim 7 as one electrode and a dielectric body interposed between the electrode and a counter electrode.

9. A method for producing a tungsten powder, comprising a step of mixing a zirconium compound and/or a hafnium compound in a raw material tungsten powder, heating the mixture in vacuum to allow the mixed compound to react with the surface of the tungsten powder particles, wherein the blending quantity of the compound is adjusted so that the content of either of zirconium element or hafnium element, which is contained in a larger amount, is 0.04 to 1 mass % in the obtained tungsten powder.

10. The method for producing a tungsten powder as claimed in claim 9, comprising a step of mixing a zirconium compound and/or a hafnium compound in a raw material tungsten powder, heating the mixture in vacuum to allow the mixed compound to react with the surface of the tungsten powder particles, wherein the blending quantity of the compound is adjusted so that the total content of zirconium element and hafnium element is 1 mass % or less in the obtained tungsten powder.

11. The method for producing a tungsten powder as claimed in claim 9, further comprising a step of granulating the tungsten powder.

12. A method for producing an anode body for a capacitor, comprising sintering the tungsten powder claimed in claim 1.
